(19) United States
(12) Patent Application Publication
(10) Pub. No.: US 2013/0199653 A1
(43) Pub. Date: Aug. 8, 2013

(54) LINE GUIDE SYSTEM FOR RECEIVING AND GUIDING SUPPLY LINES AND MACHINE TOOL

(71) Applicant: DECKEL MAHO Pfronten GmbH, Pfronten (DE)

(72) Inventors: Sebastian Riedel, Eisenberg (DE); Florian Garbarsky, Betzigau (DE)

(73) Assignee: DECKEL MAHO PFRONTEN GMBH, Pfronten (DE)

(21) Appl. No.: 13/759,871

(22) Filed: Feb. 5, 2013

(30) Foreign Application Priority Data
Feb. 6, 2012 (DE) 10 2012 002 093.7

(51) Int. Cl. F16L 3/01

(52) U.S. Cl. CPC F16L 3/01
USPC 138/106

(57) ABSTRACT

A line guide system guides supply lines between a first body and a second body that are rotatable with respect to each other from a first rotation condition into a second rotation condition. A plurality of guiding lines respectively receive the supply lines, wherein respective ends of the guiding lines are disposed in first and second fixation portions axially spaced from each other with respect to a common rotational axis. The guiding lines form first and second coil-like segments when the line guide system is moved into the first rotation condition, which segments each extend at least partially around the rotational axis and are connected to each other via an arc-shaped connecting segment. When the line guide system is moved into the second rotation condition, the respective arc-shaped connecting elements unravel such that the guiding lines each have a coil-like extension on the whole along the first coiling direction.

### FIELD

The present application relates to a line guide system for receiving and guiding supply lines between a first body and a second body which can be rotated with respect to each other about a common rotational axis across a rotational angle area. Furthermore, the present application relates to a machine tool having such line guide system.

### BACKGROUND

In machines having two bodies that can be rotated against each other or turned toward each other, such as, for example, in machine tools, it is often necessary to guide supply lines from the first body to the second body by using a line guide system. If, for example, working equipment (e.g., a motor spindle) is attached to the second body, supply lines transporting electric signals and/or fluids to and away from the working equipment usually have to be guided from the first body to the second body. As the supply lines also rotate when the first and second bodies rotate with respect to each other and as a rule are firmly connected to the first and the second body, the first and the second body can be rotated against each other only within a defined rotational angle area. In order to be able to operate the working equipment as flexibly as possible, the rotational angle area should be as large as possible. Furthermore, the line guide system should be able to receive a number of supply lines as large as possible and be designed to be compact. Line guide systems using slip rings and fluid rotary feedthroughs fulfill these requirements; however, they are usually very expensive to produce because they are highly complex components.

### SUMMARY AND INITIAL DESCRIPTION

Disclosed herein is a line guide system for use in machines of any kind, in particular for use in machine tools, which can be produced at low cost and is compact with regard to its dimensions and is able to receive and guide a multitude of supply lines.

According to at least one embodiment, a line guide system is provided for receiving and guiding supply lines between a first body and a second body which can be rotated with respect to each other about a common rotational axis across a rotational angle area such that the line guide system can be moved from a first rotation condition into a second rotation condition. The line guide system has a plurality of movable guiding lines for respectively receiving supply lines, wherein respective first ends of the guiding lines are disposed in a first fixation portion and respective second ends of the guiding lines are disposed in a second fixation portion. The first fixation portion and the second fixation portion are axially spaced apart from each other with respect to the common rotational axis. The guiding lines are adapted to form a first coil-like segment and a second coil-like segment in the first rotation condition of the line guide system, which each extend at least in part around the rotational axis and are connected with each other via an arc-shaped connecting segment. The first coil-like segment extends along the first coiling direction, and the second coil-like segment extends along a second coiling direction opposite to the first coiling direction. The guiding lines are adapted such that when the line guide system is moved into the second rotation condition, the respective arc-shaped connecting elements unravel such that the guiding lines each have a coil-like extension on the whole along the first coiling direction.

According to the present disclosure, the term “coil-like segment” includes in particular a segment of any length of an (imaginary) coil-like extension. Coil-like in the sense of the present disclosure does not necessarily include a constant pitch, but merely a constant coiling direction.

In other words, a plurality of guiding lines extending adjacently and offset with respect to one other are disposed around the rotational axis, which each have a coil-like extension on the whole (second rotation condition) or a coil-like extension in fact (first rotation condition). Thus, the respective coil-like extensions are “nested” into one another along a peripheral direction around the rotational axis. Preferably, the guiding lines are uniformly spaced apart from the rotational axis respectively across the entire extension along the rotational axis, independent of the respective rotation condition. That is, the guiding lines remain spaced apart with respect to the rotational axis at a constant distance when the line guide system is moved from the first rotation condition into the second rotation condition, and vice versa. Alternatively, corresponding parts of the guiding lines may be uniformly spaced apart from the rotational axis but the individual parts of the same may each be spaced apart from the rotational axis at varying distances.

Due to the fact that a plurality of guiding lines is used, a high number of supply lines can be guided between the first body and the second body. Due to the fact that all guiding lines unravel or create the respective arc-shaped connecting segments (preferably, but not necessarily in a synchronous manner) when the line guide system is moved from the first rotation condition, the guiding lines do not interfere with one another. Furthermore, this makes it possible to maximize the lengths of the guiding lines with respect to a particular portion of the axis (due to the forming of the arc-shaped connecting elements, an additional portion of guiding lines can be accommodated on a circumferential surface around the rotational axis whereby the length of the guiding lines can be increased). This in turn makes it possible to maximize the rotational angle area across which the first body and the second body can be rotated with respect to each other. In addition, the line length required for a particular rotational angle is minimized. Here, the arc-shaped connecting elements are formed in a defined reproducible manner and unravel in a defined reproducible manner. That is, a rotational angle area of the mutual turning of the first and second bodies toward each other within which the arc-shaped connecting segments form and unravel, respectively, and the shape of the formed arcs remain constant (or change only marginally due to an occurrence of wear), independent of how often a change has already been made back and forth between the first rotation condition and the second rotation condition. This means in particular that the arc-shaped connecting elements are not formed because of changing random influences in varying rotational angle areas and in varying shapes. In this connection, the “unraveling” of an arc-shaped connecting segment does not necessarily mean that the course of the winding within a guiding line has the same pitch everywhere but may also mean that a curvature of the arc-shaped partial piece is so small that it is not the coiling direction of the guiding line which is changed within the arc-shaped connecting segment, but merely the pitch of the winding of the guiding line.

According to an embodiment disclosed herein, the rotational angle area is at least 370°. In this case, e.g., the first body and the second body, starting from an initial position, can be rotated against each other in a positive and a negative rotational direction into a −185° position or a +185° position. In this manner, a swiveling range of 360° is completely covered and in each rotational end position)(+180°/−180° a “travel path” of 5° of an additional swiveling area is ensured.

According to an embodiment disclosed herein, in case of a maximum rotational angle area of 370°, the transition point where the arc-shaped connecting element unravels is in an angle area of 100° to 150°, in particular in an area of 115° to 135°, which allows minimization of the required guiding line length when the axial length and the rotational angle are predetermined, whereby the number of guiding lines winding along a portion of the axis may in turn be maximized.

Preferably, the guiding lines are guiding chains or tubes that can be moved/bent/twisted in three spatial directions. This makes it possible to guide the guiding lines like coils free from distortion about the rotational axis.

If the guiding lines are designed as guiding chains, the chain links are designed according to at least one embodiment such that a minimum bending radius of the guiding chains cannot fall short in all three directions in order to protect the supply lines against too strong bending.

Due to the forming or unraveling of the arc-shaped connecting elements (transition points), it is possible that, when the first and second bodies are rotated with respect to each other, corresponding coil diameters formed by the first coil-like segments and the second coil-like segments each remain constant. This in turn makes it possible to keep the line guide system compact because the coil-like segments do not radially expand in case of mutual rotation.

According to an embodiment disclosed herein, a plurality of guiding elements is provided which are each connected to the first body and extend like coils along the first coiling direction. The guiding elements are designed and in an operative connection with the guiding lines (i.e., they guide the latter) such that end portions of the guiding lines facing the first ends have a coil-like extension both in the first rotation condition and in the second rotation condition along the first coiling direction. Thus, the guiding elements ensure that, independent of the current rotation condition, at least a part of each guiding line has a coil-like extension along the first coiling direction. This also makes it possible to ensure that the sites where the arc-shaped connecting segments connect are not formed in an arbitrary manner, but in a defined manner and only within a limited area along the rotational axis.

The guiding elements may, e.g., be disposed such that in the first rotation condition, each guiding line is supported on a respective one of the guiding elements and when the guiding elements are moved into the second rotation condition, the guiding lines are lifted off the guiding elements. In this embodiment, the guiding elements ensure that the guiding lines cannot rest upon one another which could lead to mutual interference (e.g., getting caught). Furthermore, in the case of guiding lines having a high weight, squeezing events are prevented from occurring by one or more further guiding lines resting on one guiding line.

The first body may have a first hollow body formed around the rotational axis, wherein one of the guiding lines may extend on an outer surface of the first hollow body.

Furthermore, the first body may have a second hollow body formed around the first hollow body. At least one of the guiding lines may extend on an outer surface of the second hollow body. Thus, the guiding lines can be apportioned to two different coil radii so that the number of the guiding lines can be increased.

At least one of the guiding lines can extend inside a first cavity formed between the first hollow body and the second hollow body. The forming of such cavity ensures an additional guidance of the guiding lines. In particular, it is possible in this manner that the radius of the coil-like segments extending inside the first cavity neither increases nor decreases when the first and second bodies are rotated with respect to each other.

Furthermore, the first body may have a third hollow body formed around the second hollow body, and at least one of the guiding lines extending inside a second cavity formed between the second hollow body and the third hollow body. Thus, the guiding lines may be apportioned to two different cavities having different coil radii so that the number of the guiding lines can be increased.

The first and second hollow bodies may each be designed to be longer than the third hollow body. This is an advantage when, for example, guiding lines extend inside the second hollow body whose length has to be shorter than the length of the guiding lines extending inside the first cavity.

According to an embodiment disclosed herein, the second body may have a first part arranged so as to be rotatable about the first hollow body inside of or at one end of the first cavity and to which a second end of at least one guiding line is fixed. Furthermore, the second body may have a second part arranged so as to be rotatable about the second hollow body inside of or at one end of the second cavity and to which a second end of at least one guiding line is fixed. Working equipment, for example, a motor spindle, may be firmly connected to the second body. Both the first part and the second part of the second body may be firmly connected to each other.

According to an embodiment disclosed herein, the guiding lines extending through the first hollow body receive lines transporting media, and the guiding lines extending through the second hollow body receive lines transporting electric signals. This makes sense particularly in a case in which the guiding lines guiding electric lines receive a maximum number of supply lines. In this case, guiding lines guiding electric lines usually are less easy to twist than guiding lines guiding fluid lines, and thus it is easier to twist the guiding lines guiding electric lines around a hollow body that has an increased diameter.

The guiding lines extending through the first hollow body may run parallel both in the first and the second rotation condition, and the guiding lines extending through the second hollow body may run parallel both in the first and the second rotation condition. Thus, it is possible to guide the guiding lines in a maximally complication-free manner because they do not interfere with one another.

In all embodiments the guiding lines may be spaced apart uniformly from one another in order to ensure complication-free guiding of the guiding lines.

The second body may have a guiding element disposed between the second ends and the first ends of the guiding lines, the guiding element being designed such that by rotating the guiding element, the respective sites of the guiding lines where the first coil-like segments merge into the second coil-like segments are changed. As mentioned before, the controlled guidance of the guiding lines is thus ensured.

For example, the guiding element may be a guiding ring that is arranged such that each guiding line extends through a respective one of a plurality of openings formed in the guiding ring. The guiding ring may be disposed, e.g., inside the second cavity and extend concentrically around the rotational axis or the first hollow body. This makes it possible to support a part of the guiding lines by the guiding ring which eases the load of the guiding lines in case of a maximum filling of the guiding lines with supply lines and the high weight of the guiding lines resulting therefrom.

The guiding ring may be connected to the second body (e.g., to the second part of the second body) such that when the line guide system is moved into the second rotation condition, the guiding ring is co-rotated such that the part of the guiding lines located between the guiding ring and the second ends of the guiding lines forms a part of the coil-like orientation of the guiding lines, and the guiding ring being rotated such that when the line guide system is moved into the first rotation condition, the part of the guiding lines located between the guiding ring and the second ends of the guiding lines forms the second coil-like segments of the guiding lines.

Moreover, disclosed herein is a machine tool comprising a line guide system according to the invention.

The machine tool may have working equipment that is disposed on the second body and rotatable with the latter relative to the first body whereby the supply lines guided by the line guide system serve to supply electric signals and fluids to the working equipment or lead electrical signals and fluids away from the working equipment.

Furthermore, disclosed herein is a machine tool comprising a line guide system according to one of the described or following embodiments.

### DESCRIPTION OF THE DRAWINGS

In the following the invention will be described in more detail with reference to the Figures in an exemplary embodiment, wherein:

FIG. 1 shows a perspective view of a line guide system according to an embodiment of the invention;

FIGS. 2a-2d show the line guide system shown in FIG. 1 in various rotation conditions;

FIGS. 3a-3b show cross-sectional views of a part of guiding line fixation portions of the line guide system shown in FIG. 1;

FIG. 4 shows a perspective view of a line guide system according to an embodiment of the invention;

FIGS. 5a-5d show perspective views of various rotation conditions of the line guide system shown in FIG. 4;

FIG. 6 shows another perspective illustration of the line guide system shown in FIG. 4;

FIGS. 7a-7b show cross-sectional views of a part of supply line fixation portions of the line guide system shown in FIG. 4;

FIG. 8 shows a cross-sectional view of a line guide system that is a combination of the line guide systems shown in FIGS. 1 and 4;

FIG. 9 shows a perspective view of the line guide system shown in FIG. 8; and

FIG. 10 shows a schematic view of a rotational angle area that can be achieved with the line guide systems shown in FIGS. 1, 4, and 8.

### DETAILED DESCRIPTION

In the figures, identical or corresponding areas, components, or component assemblies are designated by the same reference numerals.

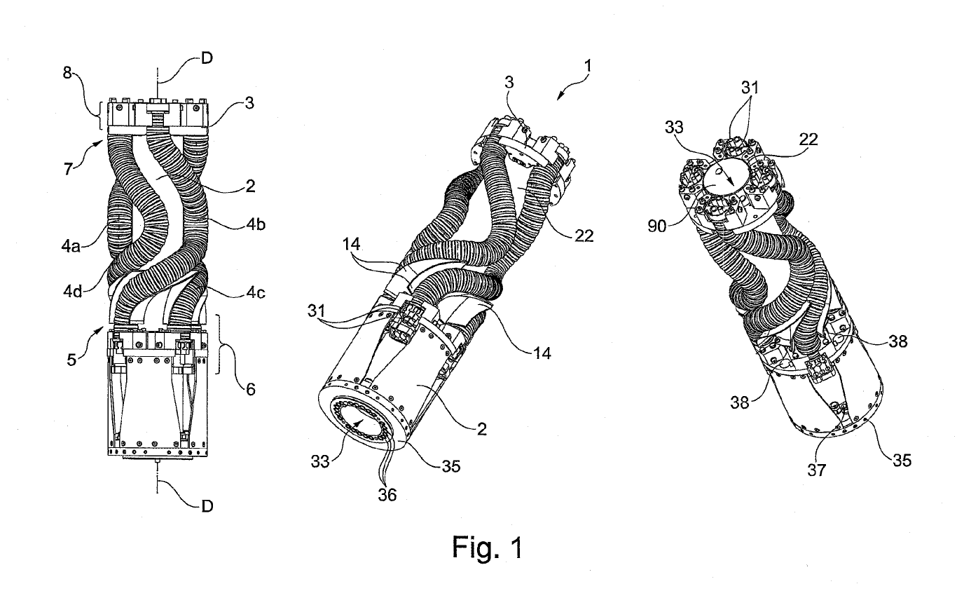

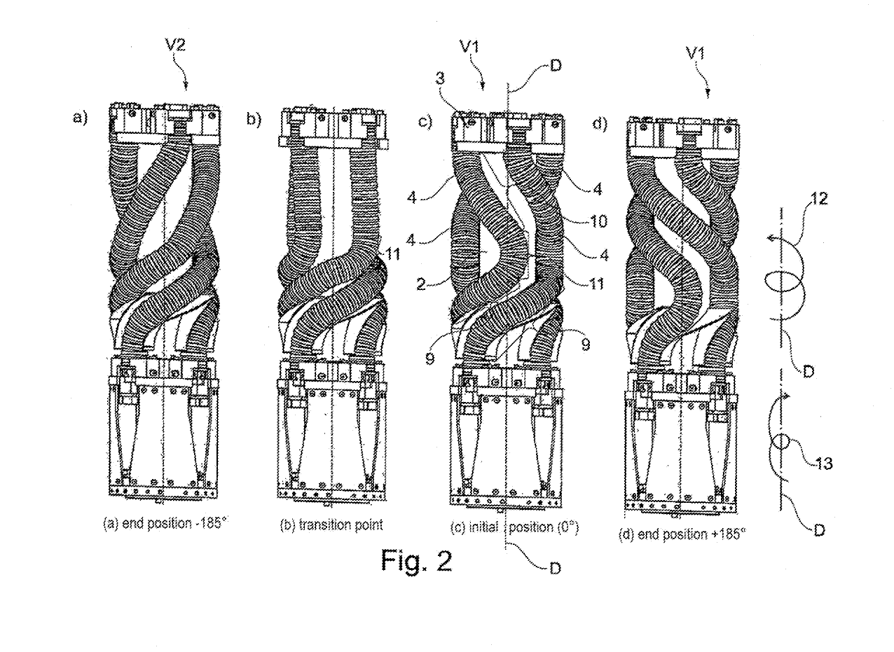

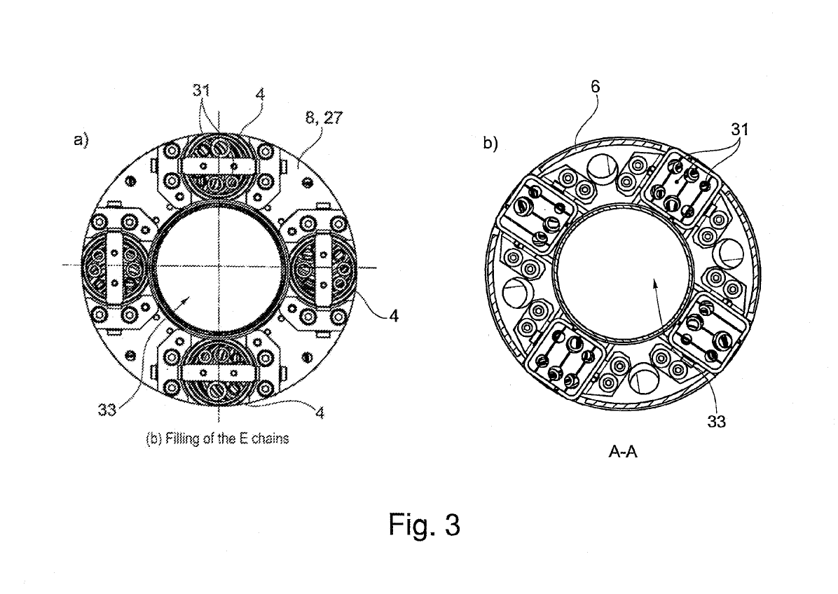

FIG. 1 shows a line guide system 1 according to at least one embodiment of the invention. The line guide system 1 has a first body 2 and a second body 3 which can be rotated with respect to each other about a common rotational axis D across a rotational angle area such that the line guide system 1 can be moved from a first rotation condition V1 into a second rotation condition V2 (see FIG. 2). The line guide system has a plurality of elastic guiding lines 4 in which supply lines 31 are respectively guided. First ends 5 of the guiding lines 4 are fixed to the first body 2 in a first fixation portion 6. Second ends 7 of the guiding lines 4 are fixed to the second body 3 in a second fixation portion 8. The first fixation portion 6 is axially spaced apart relative to the second fixation portion 8 with respect to the rotational axis D.

When the second body 3 is rotated about the rotational axis D with respect to the first body 2, the geometric shapes of the extensions of the guiding lines 4 along the outer surface of the first body 2 change from the first fixation portion 6 toward the second fixation portion 8. FIG. 2a-2d show various rotation conditions of the second body 3 relative to the first body 2 and the corresponding geometric shapes of the extensions of the guiding lines 4.

The rotation condition shown in FIG. 1 corresponds to the rotation condition shown in FIG. 2c, in what is called the “initial position condition.” In the initial position condition, each of the guiding lines 4 has a first coil-like segment 9 and a second coil-like segment 10 which respectively extend around the rotational axis D (along the outer surface of the first body 2) and are connected to each other via an arc-shaped connecting segment 11. The first coil-like segment 9 extends along a first coiling direction 12, and the second coil-like segment 10 extends along a second coiling direction 13, which is opposite to the first coiling direction 12, around the central axis D with respect to the coiling direction.

When the second body 3 is rotated clockwise, starting from the initial position condition (shown in FIG. 2c), about the rotational axis D, the rotation condition (“end position condition”) shown in FIG. 2d results. In this rotation condition, the respective lengths of the second coil-like segments 10 of the guiding lines 4 are enlarged as compared to the corresponding lengths of the second coil-like segments 10 of the rotation condition shown in FIG. 2c. Furthermore, the sites of the arc-shaped connecting segments 11 are closer to the first fixation portion 6 as compared to the rotation condition shown in FIG. 2c. Conversely, this means that the lengths of the first coil-like segments 9 of the guiding lines 10 have each decreased correspondingly.

When, on the other hand, the second body 3 is rotated counterclockwise, starting from the initial position condition (shown in FIG. 2c), against the first body 2 about the rotational axis D, the rotation condition shown in FIG. 2b results in which arc-shaped connecting segments 11 still exist (whose positions correspond to the upper ends of the first coil-like segments 9), but which are formed less “sharp.” Furthermore, the second coil-like segments 10 have “unraveled” in the sense that the guiding lines 4 now extend toward the second fixation portion 8 almost parallel to the rotational axis D, starting from the arc-shaped connecting segments 11 along the outer surface of the first body 2.

When the second body 3 is continued to be rotated counterclockwise, starting from the rotation condition shown in FIG. 2b about the rotational axis D, the rotation condition shown in FIG. 2a results in which the arc-shaped connecting elements 11 have now also unraveled such that each of the guiding lines 4 has a coil-like extension on the whole from the first fixation portion 6 to the second fixation portion 8 along the first coiling direction 12. The rotation condition shown in FIG. 2a can be referred to as the second rotation condition V2 because in this rotation condition, no more second coil-like segments 10 exist. The rotation conditions shown in FIGS. 2c and 2d can be referred to as first rotation conditions V1 because in these rotation conditions, second coil-like segments 10 exist wherein the rotation condition shown in FIG. 2d makes the characteristics which are typical of the second rotation condition emerge even more clearly than the rotation condition shown in FIG. 2c. The rotation condition shown in FIG. 2b is an intermediate condition illustrating a transition point which is approximately 120° in this example and where the coiling direction changes due to the unraveling of the arc-shaped segment.

The change of the geometric extensions of the guiding lines 4 according to the respective rotation conditions is possible without any problems because the guiding lines 4 have a flexible structure. For example, the guiding lines 4 may be guiding chains that can be moved in three spatial directions (e.g., what are called Triflex® R guiding chains).

Based on the behavior of the guiding lines 4 in the respective rotation conditions described in FIGS. 2a-2d, it is possible to keep respective corresponding diameters constant which are formed by the first coil-like segments 9 and the second coil-like segment 10. This in turn offers the advantage that the radial dimensions of the line guide system 1 do not change when the first and second bodies 2, 3 are rotated with respect to each other.

As can be seen in FIGS. 1 and 2, a plurality of guiding elements 14 is attached to the outer surface of the first body 2, which guiding elements 14 respectively extend in a coil-like fashion along the first coiling direction 12. The guiding elements 14 are arranged between the guiding lines 4 such that end portions of the guiding lines 4 facing the first ends 5 of the guiding lines 4 have a coil-like extension both in the first rotation condition V1 and in the second rotation condition V2 along the first coiling direction 12. Thus, the guiding elements 14 ensure that the lower part of the guiding lines 4 always extends along the first coiling direction 12 and never along the second coiling direction 13. In contrast thereto, the end portions of the guiding lines 4 facing the second ends 7 may extend both along the first coiling direction and along the second coiling direction in accordance with the respective rotation condition. As can be taken from FIG. 2d, the ends of the guiding elements 14 facing the second fixation portion 8 respectively mark the positions up to which the arc-shaped connecting segments 11 can be maximally moved toward the first fixation portion 6.

As can be taken from FIGS. 2a-2d, the guiding elements 14 form different pitches in different rotation conditions: In rotation conditions near the initial position condition, each guiding line 4 is supported on a respective upper surface of a guiding element 14 whereas in rotation conditions far away from the initial position condition, the guiding lines 4 are lifted off the upper surfaces of the guiding elements 14. The guiding elements 14 cause the guiding lines 4 to not rest upon one another or only in a very small proportion which, due to the high self-weight of the guiding lines 4, could lead to squeezing or mutual interferences.

The line guide system 1 has a distributor ring 35 connected to the first body 2 at the lower end thereof. Line terminals 36 are provided in the distributor ring 35 which are connected to the supply lines 31. The distributor ring 35 is connected to the first body 2 via fasteners 37 (e.g., screws). The first fixation portion 6 has bores 38 by means of which the fasteners can be reached. Thus, it is not necessary to fix the distributor ring 35 to the first body 2 from the opposite side.

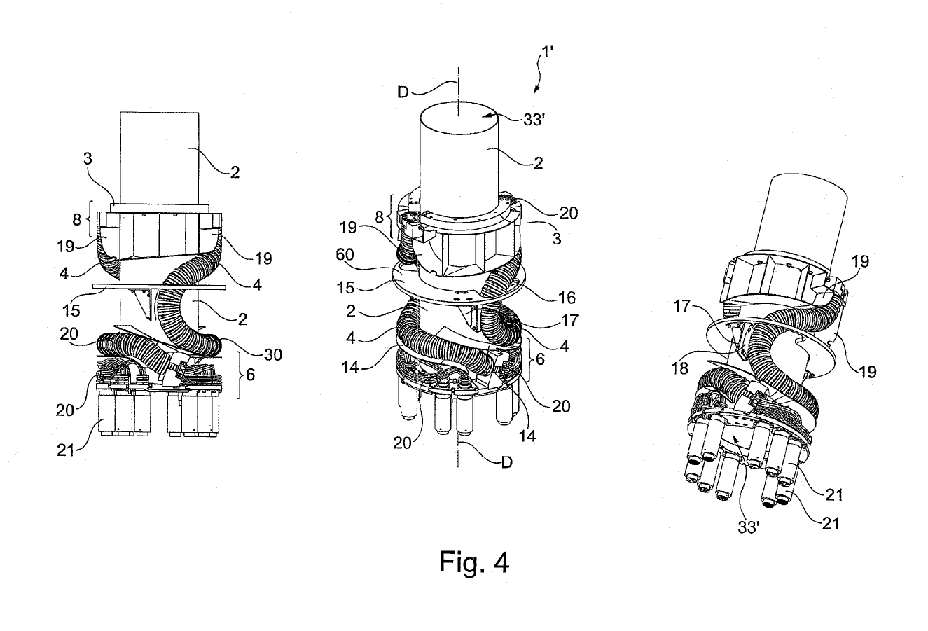

FIG. 4 shows another possible embodiment of the line guide system disclosed herein. The line guide system 1′ shown in FIG. 4 substantially corresponds to the line guide system 1 shown in FIGS. 1 and 2 as regards its structure and principle of operation. In addition, however, the second body 3 has a guiding element 15 disposed between the first fixation portion 6 and the second fixation portion 8. The guiding element 15 is designed as a loose guiding ring concentrically extending around the rotational axis D and the outer surface, respectively, of the first body 2. The guiding ring 15 has openings 16 with one of the guiding lines 4 passing through each opening 16. A further guiding element 17 is disposed on one of the sides of each opening 16 (on the lower surface of the guiding ring 15). The guiding elements 17 fixed to the loosely rotatable guiding ring perpendicularly protrude downward from the lower surface of the guiding ring 15 and may have a concave bulge 18 on the surfaces facing the guiding lines 4. The lengths of the openings 16 along the guiding ring 15 are designed to be so large (for example, twice the diameter of a guiding line 4) that the guiding lines 4 can move relatively freely inside the openings 16. The combination of the longitudinal openings 16, the guiding elements 17, and their concave surfaces 18 makes it possible that the guiding lines 4 can be moved back and forth well between the first rotation condition and the second rotation condition.

The second body 3 has further guiding elements 19 in the second fixation portion 8 which surround the second ends 7 of the guiding elements 4 on both sides and allow some clearance of the guiding lines 4 along a peripheral direction around the rotational axis D. The guiding elements 19 each have a convex extension directed toward the guiding lines 4 to which the guiding lines 4 can fit tightly. In the first rotation condition, the guiding lines 4 fit tightly to one respective guiding element 19, and in the first rotation condition to the respective other one. Thus, it is possible to prevent the guiding lines 4 from rotating and bending too strongly in the second fixation portion 8.

Furthermore, FIG. 4 shows supply lines 20 exiting the lower ends 5 of the guiding lines 4 and entering line receiving elements 21 arranged parallel to the rotational axis D and connected to the first body 2.

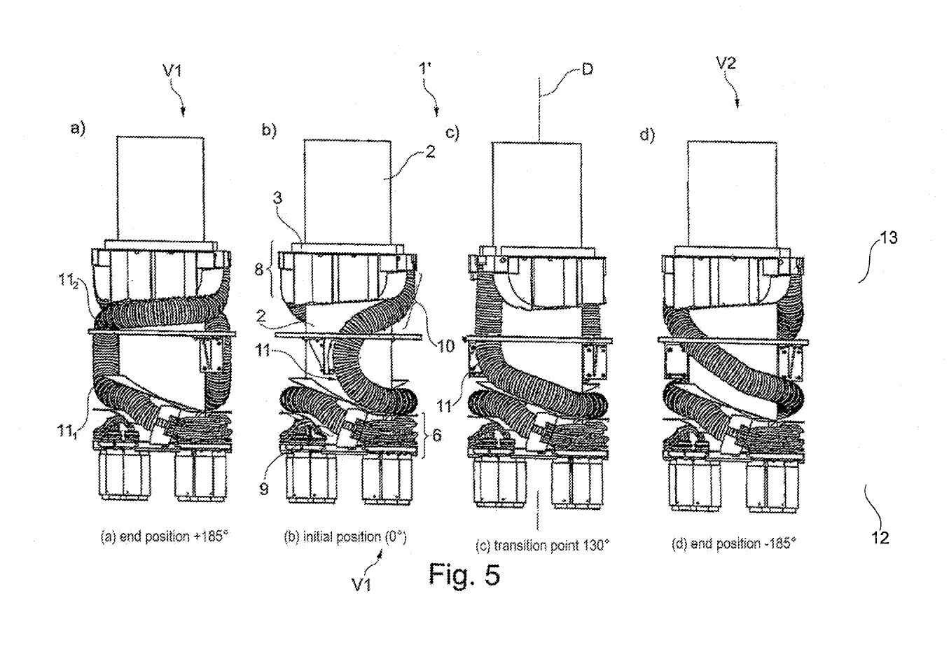

FIG. 5 shows various rotation conditions of a line guide system 1′ in analogy to FIG. 2.

The rotation condition shown in FIG. 4 corresponds to the rotation condition shown in FIG. 5b, the “initial position state.” In the initial position state, each of the guiding lines 4 has a first coil-like segment 9 and a second coil-like segment 10 respectively extending around the rotational axis D along a coiling direction (along the outer surface of the first body 2) and being connected to each another via an arc-shaped connecting segment 11. The first coil-like segment 9 extends along a first coiling direction 12, and the second coil-like segment 10 extends along a second coiling direction 13 directly opposed to the first coiling direction 12 as concerns its sign.

If the second body 3, starting from the initial position state shown in FIG. 5b, is rotated counterclockwise about the rotational axis D, the rotation condition (“end position state”) shown in FIG. 5a results. In this rotation condition, the respective lengths of the second coil-like segments 10 of the guiding lines 4 are increased as compared to the corresponding lengths of the second coil-like segment 10 of the rotation condition shown in FIG. 5b. Furthermore, the sites of the arc-shaped connecting segments 11 are located closer to the second fixation portion 8 as compared to the rotation condition shown in FIG. 5b. Conversely, this means that the lengths of the first coil-like segments 9 of the guiding lines 4 have each shortened correspondingly. In the rotation condition shown in FIG. 5a, the arc-shaped connecting segment 11 “splits” into two connecting segments 111 and 112, the first connecting segment 111 being located at an upper end of the corresponding guiding element 14, and the second connecting segment 112 being located at the respective opening 16 of the guiding element 15. In this rotation condition, the corresponding guiding element 19 causes the guiding line 4 between the guiding element 15 and the second fixation portion 8 not to bulge too strongly toward the second fixation portion 8.

If, on the other hand, the second body 3, starting from the initial position state shown in FIG. 5b, is rotated clockwise about the rotational axis D, the rotation condition shown in FIG. 5c results in which arc-shaped connecting segments 11 still exist (whose positions correspond to the upper ends of the first coil-like segments), however, are formed less “sharply.” Furthermore, the second coil-like segments 10 have “unraveled” at a transition point of approximately 130° in the sense that the guiding lines 4, starting from the arc-shaped connecting segments 11, now extend toward the second fixation portion 8 almost parallel to the rotational axis D along the outer surface of the first body 2.

When the second body 3, starting from the rotation condition shown in FIG. 5c, is further rotated clockwise about the rotational axis D, the rotation condition shown in FIG. 5d results in which the arc-shaped connecting elements 11 have now also unraveled such that each of the guiding lines 4 has a respective coil-like extension on the whole from the first fixation portion 6 to the second fixation portion 8 along the first coiling direction 12.

The rotation condition shown in FIG. 5d can be referred to as a second rotation condition V2 because in this rotation condition, no second coil-like segments 10 exist anymore. The rotation conditions shown in FIGS. 5a and 5b can be referred to as first rotation conditions V1 because in these rotation conditions, second coil-like segments 10 exist wherein the rotation condition shown in FIG. 5a makes the characteristics typical of the second rotation condition emerge even more clearly than the rotation condition shown in FIG. 5b. The rotation condition shown in FIG. 5c is an intermediate state.

It can be taken from FIGS. 5a and 5d that the guiding ring 15 is rotated when the line guide system 1′ is moved into the second rotation condition V2 such that the part of the guiding lines 4 that is located between the guiding ring 15 and the second ends 7 of the guiding lines 4 forms a part of the coil-like orientation of the guiding lines along the first coiling direction 12. When the line guide system 1′ is moved into the first rotation condition V1, the guiding ring 15 is rotated such that the part of the guiding lines 4 located between the guiding ring 15 and the second ends 7 of the guiding lines 4 forms the second coil-like segments of the guiding lines 4 along the second coiling direction 13.

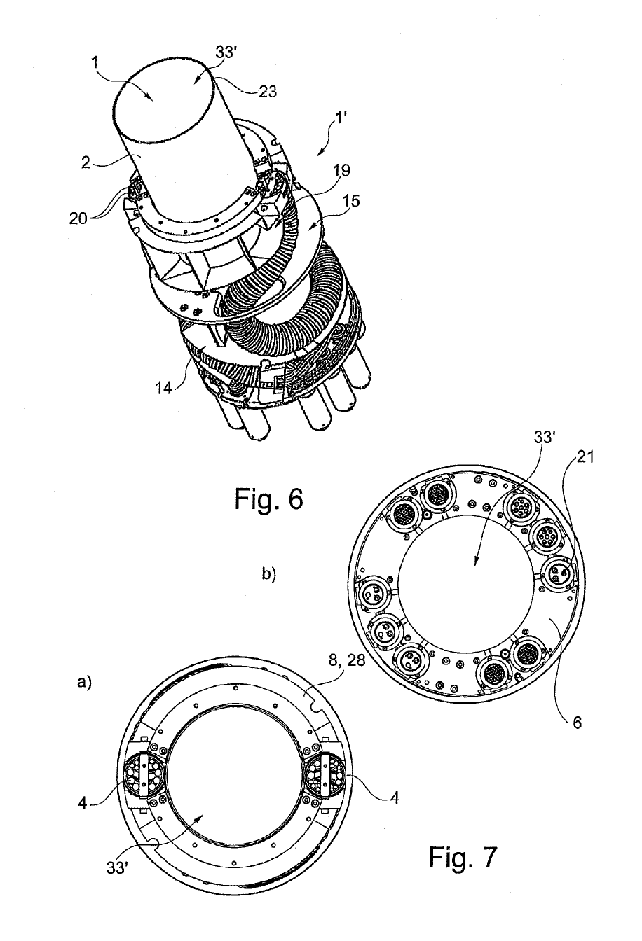

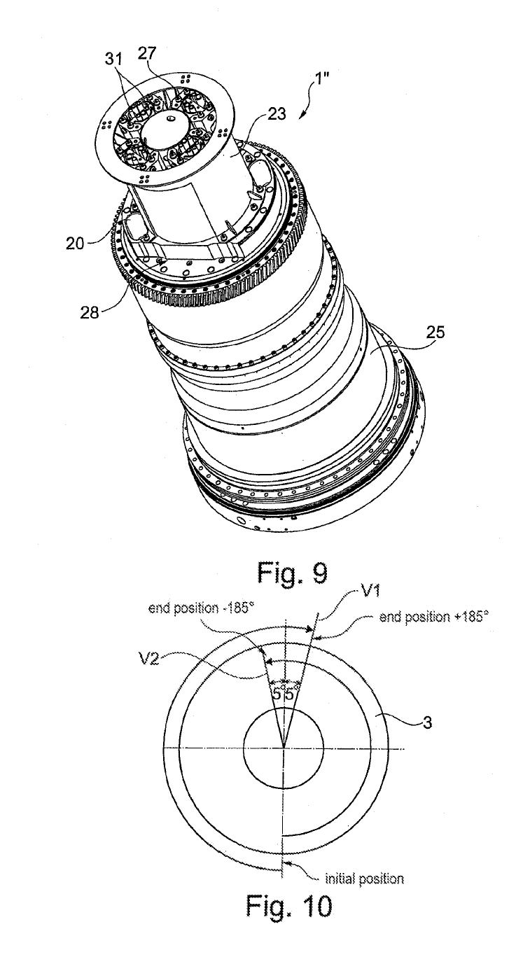

According to an embodiment disclosed herein, the line guide system 1 and the line guide system 1′ may be combined to form a combined line guide system 1″, which is shown in FIGS. 8 and 9. To this end, as shown in FIG. 6, the line guide system 1 can be inserted inside the first body 2 (hollow body 23) of the line guide system 1′. It is an advantage that each of the line guide system 1 and the line guide system 1′ can separately be pre-assembled completely so that merely the line guide system 1 has to be inserted inside the first body 2 of the line guide system 1′. Thus, assembly time of this complicated component can be considerably shortened, which saves cost.

In this embodiment, the first body 2 may have a first hollow body 22 formed around the rotational axis D and a second hollow body 23 formed around the first hollow body 22. At least one of the guiding lines 4 extends inside a first cavity 24 formed between the first hollow body 22 and the second hollow body 23. The first body 2 in this embodiment has a third hollow body 25 formed around the second hollow body 23. At least one of the guiding lines 4 extends inside a second cavity 26 formed between the second hollow body 23 and the third hollow body 25. Inside the first hollow body 22, an input shaft of a working spindle can be guided, if necessary, which is mounted to the system 1″ at the side of the head 29. In this embodiment, a length L1 of the first and second hollow bodies 22, 23 is longer than a length L2 of the third hollow body 25.

In this embodiment, the second body 3 has a first part 27 disposed at the upper end of the first cavity 24 and disposed to be rotatable about the first hollow body 22 (ring-shaped element). The second ends 7 of those guiding lines 4 that extend inside the first cavity 24 are fixed to the first part 27. Further, the second body 3 has a second part 28 which is disposed at the upper end of the second cavity 26 so as to be rotatable about the second hollow body 23 and to which second ends of the guiding lines 4 are fixed which extend through the second cavity 26. The second part 28 of the second body 3 is also a ring-shaped element.

The guiding lines extending through the first hollow body 24 may receive lines that transport media, such as fluid media, and the guiding lines 4 extending through the second hollow body 26 may receive lines transporting electric signals. This provides a particular advantage when the guiding lines transporting electric signals have to receive a large number of cables because the twisting of these guiding lines 4 is not as easy as the twisting of those guiding lines that transport media. As the second cavity 26 is further spaced apart radially from the rotational axis D than the first cavity 24, the guiding lines 4 receiving supply lines for transporting electric signals need not be twisted so strongly.

FIG. 9 shows the line guide system 1″ shown in FIG. 8 from the outside in an assembled state. In this embodiment, the number of the guiding lines guided through the first cavity 24 is four. Furthermore, the number of the guiding lines guided through the second cavity 26 is two.

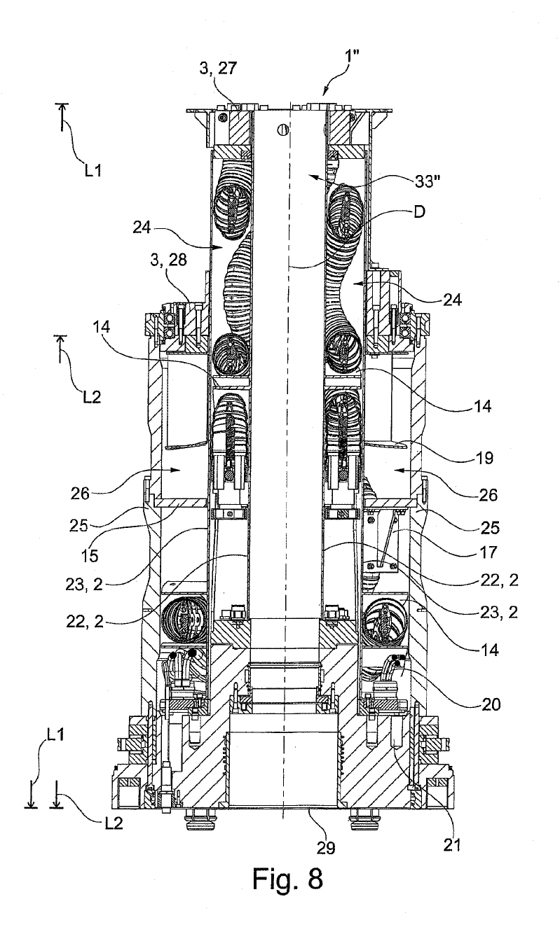

Accordingly, in FIG. 3a showing a top view of the upper end of the second fixation portion 8 of the line guide system 1, the ends of four guiding lines 4 can be seen. The supply lines 31 disposed inside the guiding lines 4 for transporting fluids can also be seen. FIG. 3b shows a top view of a part of the first fixation portion 6 (fixation ring) to which the lower ends of the supply lines 31 are fixed which extend inside the first cavity 24. Correspondingly thereto, FIGS. 7a and 7b show parts of the first fixation portion 6 and the second fixation portion 8 of the guide system 1′ to which the guiding lines 4 extending inside the second cavity 26 are fixed within which the supply lines 20 extend.

Inside the interior 33″ of the first hollow body 22 of the line guide system 1″, an input shaft may be provided. This applies analogously to interiors 33/33′ of the first body 2 of the line guide system 1/1′, should the former be formed as a hollow shape.

The invention is not confined to the presented exemplary embodiments but comprises further combinations of the structural details presented in this description so as to create further exemplary embodiments according to a required use based on the knowledge of a person skilled in the art.

The embodiments of the invention in which an exclusive property or privilege is claimed are defined as follows:

1. A line guide system for receiving and guiding supply lines between a first body and a second body, which can be rotated with respect to each other about a common rotational axis across a rotational angle area such that the line guide system can be moved from a first rotation condition into a second rotation condition, the line guide system having a guiding line guiding the supply lines, the first end of which being fixed to the first body in a first fixation portion and the second end of which being fixed to the second body in a second fixation portion, the first fixation portion and the second fixation portion being axially spaced apart from each other with respect to the common rotational axis,
wherein a plurality of elastic guiding lines is provided for respectively receiving supply lines, respective first ends of the guiding lines being disposed in the first fixation portion and respective second ends of the guiding lines being disposed in the second fixation portion,
wherein the guiding lines are configured to respectively form a first coil-like segment and a second coil-like segment when the line guide system is moved into the first rotation condition, which segments each extend at least partially around the rotational axis and are connected to each other via an arc-shaped connecting element, the first coil-like segment extending along a first coiling direction and the second coil-like segment extending along a second coiling direction opposite to the first coiling direction, and
wherein the guiding lines are configured such that the respective arc-shaped connecting elements unravel when the line guide system is moved into the second rotation condition such that the guiding lines each have a coil-like extension on the whole along the first coiling direction.

2. The line guide system according to claim 1,
wherein the rotational angle area is at least 370° from −185° to +185°.

3. The line guide system according to claim 2,
wherein the transition point where the arc-shaped connecting segments unravel is in a range between 100° and 150°.

4. The line guide system according to claim 1,
wherein the guiding lines are guiding chains that can be moved in three spatial directions.

5. The line guide system according to claim 1,
wherein corresponding coil diameters that are formed by the first coil-like segments and the second coil-like segments each remain constant when the first and second bodies are rotated with respect to each other.

6. The line guide system according to claim 1,
comprising a plurality of guiding elements respectively connected to the first body and extending in a coil-like manner along the first coiling direction, the guiding elements being configured and disposed such that end portions of the guiding lines facing the first ends have a coil-like extension along the first coiling direction both in the first rotation condition and the second rotation condition.

7. The line guide system according to claim 6,
wherein the guiding elements are disposed such that in the first rotation condition, each guiding line is supported on a respective one of the guiding lines and that the guiding lines are lifted off the guiding elements in a movement from the first rotation condition into the second rotation condition.

8. The line guide system according to claim 1,
wherein the first body has a first hollow body formed around the rotational axis, and a second hollow body formed around the first hollow body, with at least one of the guiding lines extending inside a first cavity formed between the first hollow body and the second hollow body.

9. The line guide system according to claim 8,
wherein at least one of the guiding lines extends on an outer surface of the second hollow body.

10. The line guide system according to claim 8,
wherein the first body has a third hollow body formed around the second hollow body and at least one of the guiding lines extends inside a second cavity formed between the second hollow body and the third hollow body.

11. The line guide system according to claim 10,
wherein the first and second hollow bodies are each longer than the third hollow body.

12. The line guide system according to claim 8,
wherein the second body has a first part disposed inside the first cavity so as to be rotatable about the first hollow body and to which a second end of at least one guiding line is fixed, and
wherein the second body has a second part disposed inside the second cavity so as to be rotatable about the second hollow body and to which a second end of at least one guiding line is fixed.

13. The line guide system according to claim 8,
wherein the guiding lines extending through the first hollow body receive lines transporting media and wherein the guiding lines extending through the second hollow body receive lines transporting electric signals.

14. The line guide system according to claim 8,
wherein the guiding lines extending through the first hollow body extend parallel to one another both in the first and second rotation conditions, and wherein the guiding lines extending through the second hollow body extend parallel to one another both in the first and second rotation conditions.

15. The line guide system according to claim 1,
wherein the second body has a guiding element disposed between the second ends and the first ends of the guiding lines, the guiding element being configured such that by rotating the guiding element, the respective sites in the guiding lines where the first coil-like segments merge into the second coil-like segments are changed.

16. The line guide system according to claim 15,
wherein the guiding element is a guiding ring and each guiding line passes through a respective opening formed in the guiding ring.

17. The line guide system according to claim 16,
wherein when the line guide system is moved into the second rotation condition, the guiding ring is rotated such that the part of the guiding lines located between the guiding ring and the second ends of the guiding lines forms a part of the coil-like orientation of the guiding lines, and
wherein when the line guide system is moved into the first rotation condition, the guiding ring is rotated such that the part of the guiding lines located between the guiding ring and the second ends of the guiding lines forms the second coil-like segments of the guiding lines.

18. A machine tool comprising a line guide system according to claim 1.

19. The machine tool according to claim 18, further comprising working equipment that is disposed on the second body and rotatable together with the second body relative to the first body, wherein the supply lines guided by the line guide system serve to supply the working equipment with electric signals and fluids and/or to lead electric signals and fluids away from the working equipment.
